(19) United States
(12) Patent Application Publication
(10) Pub. No.: US 2004/0232857 A1
(43) Pub. Date: Nov. 25, 2004

(54) CRT device with reduced fluctuations of beam diameter due to brightness change

(76) Inventors: Takashi Itoh, Amagasaki-shi (JP); Masahide Yamauchi, Kyoto-shi (JP); Koji Fujii, Kashihara-shi (JP)

Correspondence Address: Joseph W. Price, SNELL & WILMER L.L.P., Suite 1200, 1920 Main Street, Irvine, CA, 92614-7230, US

(21) Appl. No.: 10/797,895

(22) Filed: Mar. 9, 2004

(30) Foreign Application Priority Data
Mar. 14, 2003 (JP) 2003-70005

(51) Int. Cl. G09G 1/04

(52) U.S. Cl. 315/364

(57) ABSTRACT

A CRT device includes a cold cathode electron gun realizing high resolution in all current areas. A field emitter type cathode having a field emitter array and a gate electrode, a first grid electrode, and a second grid electrode constituting the electron gun are arranged in this order toward a phosphor screen. The potential Vgate of the gate electrode is higher as the beam current is larger. The potential Vg1 of the first grid electrode takes a fixed value smaller than the potential Vgate. As the beam current increases, electrons passing through the gate electrode are accelerated more and converged to a lesser degree, whereas the lens strength of the cathode lens formed by the gate electrode, the first grid electrode, and the second grid electrode is enhanced more. Therefore, the beam diameter at the main lens can be made uniform regardless of the amount of beam current.

This application is based on application No. 2003-70005 filed in Japan, the contents of which are hereby incorporated by reference.

### BACKGROUND OF THE INVENTION

(1) Field of the Invention

The present invention relates to a cathode-ray tube (CRT) device including a cold cathode electron gun of field emitter type.

(2) Related Art

In general, CRT devices display an image by emitting an electron beam from an electron gun to a phosphor screen. An area on the phosphor screen where the electron beam strikes to produce fluorescence is referred to as a “spot”. The resolution of CRT devices depends on the diameter of the spot. To be specific, the resolution is higher as the spot diameter is smaller, and the resolution is lower as the spot diameter is larger.

In CRT devices, brightness of each pixel is changed by adjusting an amount of current carried by an electron beam (hereafter referred to as a “beam current”) To be specific, the brightness is higher as the beam current is larger, and the brightness is lower as the beam current is smaller.

The spot diameter also changes depending on the beam current. To maintain high resolution regardless of the beam current, it is preferable that a main electric field lens formed by an electron gun (hereafter referred to as a “main lens”) satisfies its optimal focus condition throughout all areas of beam currents. To realize this, the diameter of the electron beam passing through the main lens (hereafter referred to as the “beam diameter at the main lens”) needs to remain uniform regardless of the change of the beam current.

In hot cathode electron guns, however, the beam diameter at the main lens changes according to the change of the beam current. Therefore, CRT devices using a hot cathode electron gun fail to maintain high resolution.

FIG. 1 is a cross sectional view showing the construction of a typical hot cathode electron gun. As shown in FIG. 1, the hot cathode electron gun 1 includes a hot cathode 10, a control electrode 11, an accelerating electrode 12, a focusing electrode 13, and a final accelerating electrode 14. The hot cathode 10, the control electrode 11, and the accelerating electrode 12 form a cathode lens 16. The accelerating electrode 12 and the focusing electrode 13 form a pre-focusing lens 17. The focusing electrode 13 and the final accelerating electrode 12 form a main lens 18.

An electron beam emitted from the hot cathode 10 is accelerated and converged by the cathode lens 16, to form a crossover 15. This crossover 15 results in a spot on a phosphor screen, via focusing of the electron beam by the main lens 18 to form an image on the phosphor screen.

The cathode potential decreases as the beam current increases, so that the cathode lens 16 weakens accordingly. This causes the crossover 15 to approach the pre-focusing lens 17, and increases an operation area of the hot cathode 10 (a cathode area where electrons are emitted), thereby increasing an angle of divergence of the electron beam at the crossover 15. As a result, the lens effect of the pre-focusing lens 17 weakens. Due to the weakened lens effect of the pre-focusing lens 17 and the increased divergence angle at the crossover 15 described above, the beam diameter 19 at the main lens 18 increases, causing the resolution to deteriorate.

### SUMMARY OF THE INVENTION

In view of the above problem, the object of the present invention is to provide a CRT device that can maintain high resolution regardless of the amount of beam current.

The above object of the present invention can be achieved by a cathode-ray tube device including: a phosphor screen; and a cold cathode electron gun that includes (a) a cold cathode having a field emitter array that emits a beam of electrons toward the phosphor screen, and a gate electrode that controls the emission, (b) a first grid electrode that is positioned between the cold cathode and the phosphor screen, (c) a second grid electrode that is positioned between the first grid electrode and the phosphor screen, (d) an electron speed control unit operable to accelerate the electrons that have passed through the gate electrode, by a greater degree as a beam current carried by the beam of the electrons is larger, and (e) a lens strength control unit operable to enhance a lens strength of an electron lens that is formed by the gate electrode, the first grid electrode, and the second grid electrode, by a greater degree as the beam current is larger.

According to this construction, the beam diameter at the main lens can be made uniform regardless of the amount of beam current. Therefore, high resolution of the CRT device can be maintained.

In this case, it is preferable that a distance from the gate electrode to one edge of the first grid electrode closer to the phosphor screen in a thickness direction of the first grid electrode is in a range of 0.10 to 0.35 mm inclusive. It is also preferable that the first grid electrode has a through-hole that allows the beam of the electrons to pass through, and a diameter of the through-hole is in a range of 0.15 to 0.60 mm inclusive.

Also, in the CRT device of the present invention, a potential of the first grid electrode may be lower than a potential of the gate electrode, regardless of an amount of the beam current, and the potential of the gate electrode may be higher as the beam current is larger.

Further, in the CRT device of the present invention, the cold cathode may include a peripheral focusing electrode that is provided on a periphery of the gate electrode, that has a thickness substantially equal to a thickness of the gate electrode, and that has a lower potential than the gate electrode.

According to this construction, the lens strength of the cathode lens can be enhanced, so that the electron beam can be concentrated into a finer thread. Therefore, the spot diameter can be reduced, and the resolution of the CRT device can be improved. The same effects can also be obtained when the peripheral focusing electrode and the first grid electrode are integrally formed.

Also, in the CRT device of the present invention, the lens strength control unit may enhance the lens strength to form a crossover in the beam of the electrons, at one side of the gate electrode closer to the phosphor screen.

According to this construction, the diameter of the object of the main lens can be reduced. Therefore, the spot diameter can be reduced, and the resolution of the CRT device can be improved.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1 is a cross sectional view showing the construction of a typical hot cathode electron gun;

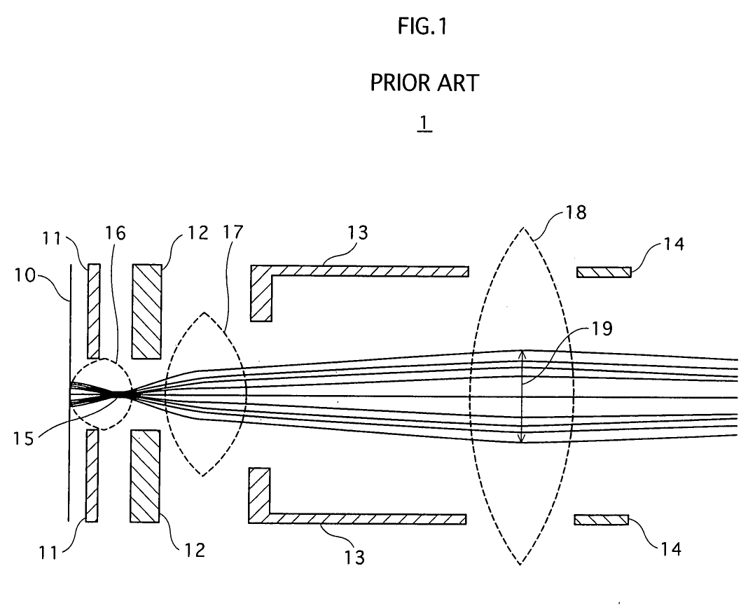

FIG. 2 is a cross sectional view schematically showing the construction of a CRT device relating to a preferred embodiment of the present invention;

FIG. 3 is a cross sectional view showing a main construction of a cold cathode electron gun 20 relating to the embodiment of the present invention;

FIG. 4 is a graph comparing the cold cathode electron gun 20 relating to the embodiment of the present invention and another cold cathode electron gun, in terms of fluctuations of a beam diameter at a main lens according to a beam current;

FIG. 5 is a graph comparing the cold cathode electron gun 20 relating to the embodiment of the present invention and a hot cathode electron gun, in terms of fluctuations of a beam diameter at a main lens according to a beam current;

FIG. 6 is a cross sectional view showing a main construction of an electron gun relating to modification (1) of the present invention; and

FIG. 7 is a cross sectional view showing a main construction of an electron gun relating to modification (2) of the present invention.

### DESCRIPTION OF THE PREFERRED EMBODIMENT

The following describes a CRT device relating to a preferred embodiment of the present invention, with reference to the drawings.

[1] Construction of the CRT Device

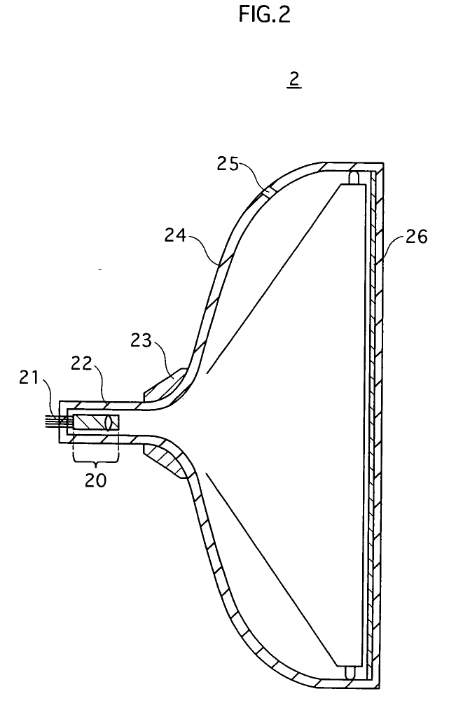

FIG. 2 is a cross sectional view schematically showing the construction of the CRT device relating to the embodiment of the present invention. The CRT device 2 includes a glass bulb 24, a phosphor screen 26, a cold cathode electron gun 20, and a deflection yoke 23. The cold cathode electron gun 20 is sealed in a neck part 22 of the glass bulb 24. The deflection yoke 23 is set at an outer circumference of the glass bulb 24. In a funnel part of the glass bulb 24, an anode button 25 is provided.

[2] Construction of the Electron Gun

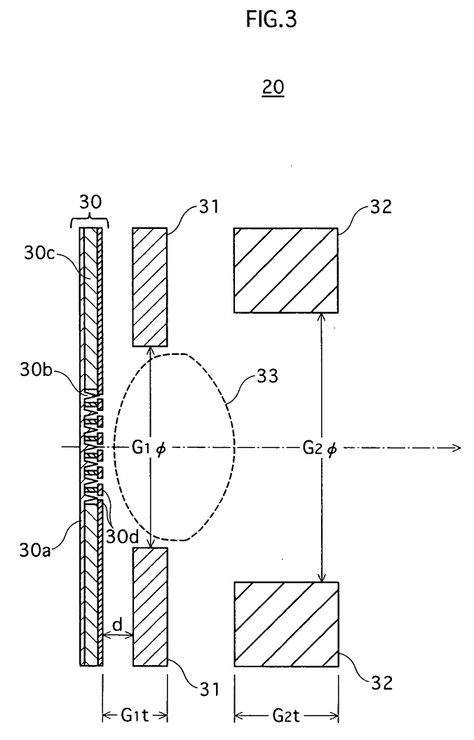

FIG. 3 is a cross sectional view showing a main construction of the cold cathode electron gun 20. As shown in FIG. 3, the cold cathode electron gun 20 includes a cathode 30 of field emitter type, a first grid electrode 31, and a second grid electrode 32. The cathode 30, the first grid electrode 31, and the second grid electrode 32 are arranged in the stated order, to share the same axis, in the direction from where a stem part 21 is positioned to where the phosphor screen 26 is positioned in the CRT device 2. The first grid electrode 31 is grounded via the stem part 21 and is set at 0V. To the second grid electrode 32, a voltage of 900V is applied from the stem part 21.

Although not shown in the figure, a third grid electrode and a fourth grid electrode are arranged in the stated order between the second grid electrode 32 and the phosphor screen 26. The third and fourth grid electrodes form a main lens. To the fourth grid electrode, a voltage of about 30kV is applied from the anode button 25 via an inner wall of the glass bulb 24. To the third grid electrode, a voltage of about 7160V is applied from the stem part 21. These voltages applied cause the main lens (not shown) to be formed. Further, the third grid electrode, together with the second grid electrode 32, forms a pre-focusing lens (not shown).

As shown in FIG. 3, the cathode 30 includes a substrate 30a, a field emitter array 30b, an insulation layer 30c, and a gate electrode 30d. On the substrate 30a, the field emitter array 30b is formed, and also the insulation layer 30c is formed to surround the field emitter array 30b. On the other main surface of the insulation layer 30c, the gate electrode 30d is formed. The gate electrode 30d, together with the first grid electrode 31 and the second grid electrode 32, forms a cathode lens 33.

For dimensions of the first grid electrode 31, the diameter G₁φ of its through hole is 0.500 mm, its thickness plus the distance from the gate electrode 30d of the cathode 30 G₁t (hereafter referred to as the “thickness-plus-distance G₁t”) that is specifically the distance from the gate electrode 30d to one edge of the first grid electrode 31 closer to the phosphor screen 26 in the thickness direction, is 0.2500 mm, and the distance d from the gate electrode 30d of the cathode 30 to the first grid electrode 31 is 0.0800 mm. Also, the field emitter array 30b has a diameter of 0.080 mm.

For dimensions of the second grid electrode 32, the diameter G₂φ of its through hole is 0.500 mm, and its thickness G₂t is 0.3500 mm. The distance G₁-G₂ between the first grid electrode 31 and the second grid electrode 32 is 0.2000 mm.

[3] Operational Principle of the Electron Gun

The cathode 30 forms a high electric field at the tips of the field emitters by generating a potential difference between the field emitter array 30b and the gate electrode 30d, and thereby emits electrons. In the present embodiment, the cold cathode electron gun 20 is controlled in such a manner that the potential Vgate of the gate electrode 30d is higher as the beam current is larger, and that the first grid electrode 31 is maintained at a fixed potential, i.e., the potential Vg1 (0V in the present embodiment), which is always lower than the potential Vgate.

By such settings, a potential difference between the field emitter array 30b and the gate electrode 30d becomes larger as the beam current becomes larger, and the speed at which the emitted electron beam passes through the gate electrode 30d becomes higher accordingly. The electron beam passing through the gate electrode 30d at higher speed is converged to a lesser degree by the cathode lens 33. This means that the electron beam receives such an action that causes the beam diameter at the main lens to increase.

On the other hand, the potential Vgate becomes higher as the beam current becomes larger, and a potential difference between the potential Vg1 and the potential Vgate becomes larger accordingly. The larger potential difference between the potential Vg1 and the potential Vgate enhances the lens strength of the cathode lens 33. This means that the electron beam receives such an action that causes the beam diameter of the electron beam entering the main lens to decrease.

In other words, the electron beam receives the conflicting actions of causing the beam diameter to increase and decrease. These conflicting actions offset each other. As a result, the beam diameter at the main lens can be maintained substantially uniform even if the beam current increases.

[Evaluations]

The following describes the results of evaluations on how the beam diameter is fluctuated according to the beam current.

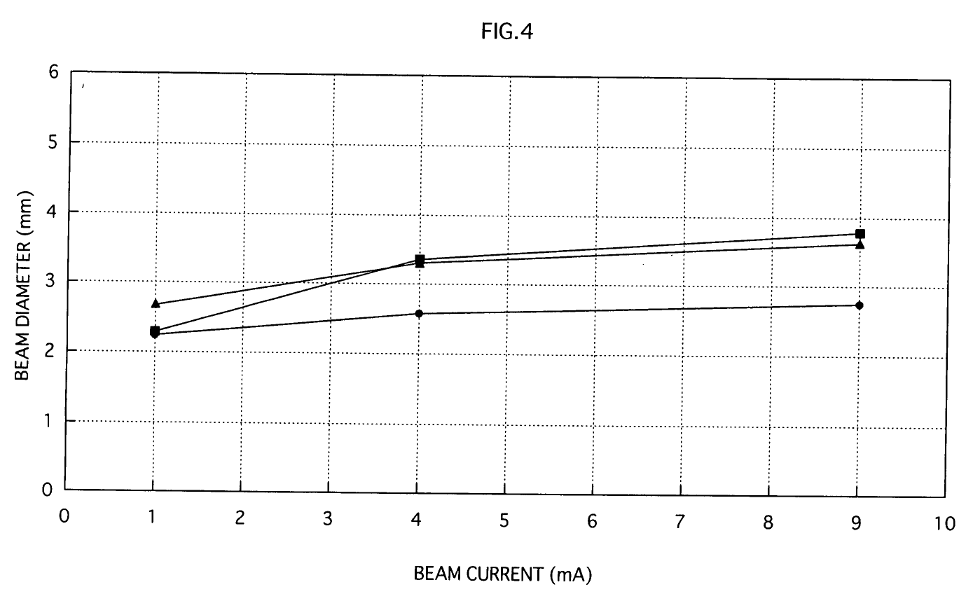

FIG. 4 is a graph comparing the cold cathode electron gun 20 relating to the embodiment of the present invention and another cold, cathode electron gun, interms of fluctuations of the beam diameter at the main lens according to the beam current. In FIG. 4, the circular points indicate data of the cold cathode electron gun 20 relating to the present embodiment, and the triangular points and the rectangular points respectively indicate data of two cathode electrode guns that differ from the cold cathode electron gun 20 only in the dimensions of their first grid electrodes.

The cold cathode electron gun whose data are shown by the triangular points includes the first grid electrode whose through-hole diameter G₁φ is 0.525 mm and thickness-plus-distance G₁t is 0.2375 mm. The cold cathode electron gun whose data are shown by the rectangular points includes the first grid electrode whose through-hole diameter G₁φ is 0.550 mm and thickness-plus-distance G₁t is 0.2250 mm. For both the cold cathode electron guns, the distance d from the gate electrode of the cathode to the first grid electrode is 0.0800 mm.

As shown in FIG. 4, for the cold cathode electrode gun 20 relating to the present embodiment, the beam diameter at the main lens is 2.23 mm when the beam current is 1 mA, 2.60 mm when the beam current is 4 mA, and 2.73 mm when the beam current is 9 mA. A fluctuation range of the beam diameter is therefore 0.50 mm.

For the cold cathode electrode gun whose data are indicated by the triangular points, the beam diameter at the main lens is 2.68 mm when the beam current is 1 mA, 3.34 mm when the beam current is 4 mA, and 3.61 mm when the beam current is 9 mA. A fluctuation range of the beam diameter is therefore 0.93 mm.

For the cold cathode electrode gun whose data are indicated by the rectangular points, the beam diameter at the main lens is 2.28 mm when the beam current is 1 mA, 3.35 mm when the beam current is 4 mA, and 3.75 mm when the beam current is 9 mA. A fluctuation range of the beam diameter is therefore 1.47 mm.

As can be seen from these data, the fluctuation range of the beam diameter at the main lens is smaller as the through-hole diameter G₁φ of the first grid electrode is smaller, and also the fluctuation range of the beam diameter at the main lens is smaller as the thickness-plus-distance G₁t of the first grid electrode is larger.

Here, because the potential of the third grid electrode and the potential of the fourth grid electrode are fixed regardless of the beam current, the speed of electrons in the electron beam passing through the pre-focusing lens or the main lens is substantially fixed regardless of the beam current. In other words, the speed of electrons in the electron beam changes due to the change of the beam current only when the electron beam passes through the cathode lens. For this reason, simply adjusting the first grid electrode can reduce the fluctuations of the beam diameter at the main lens as described above.

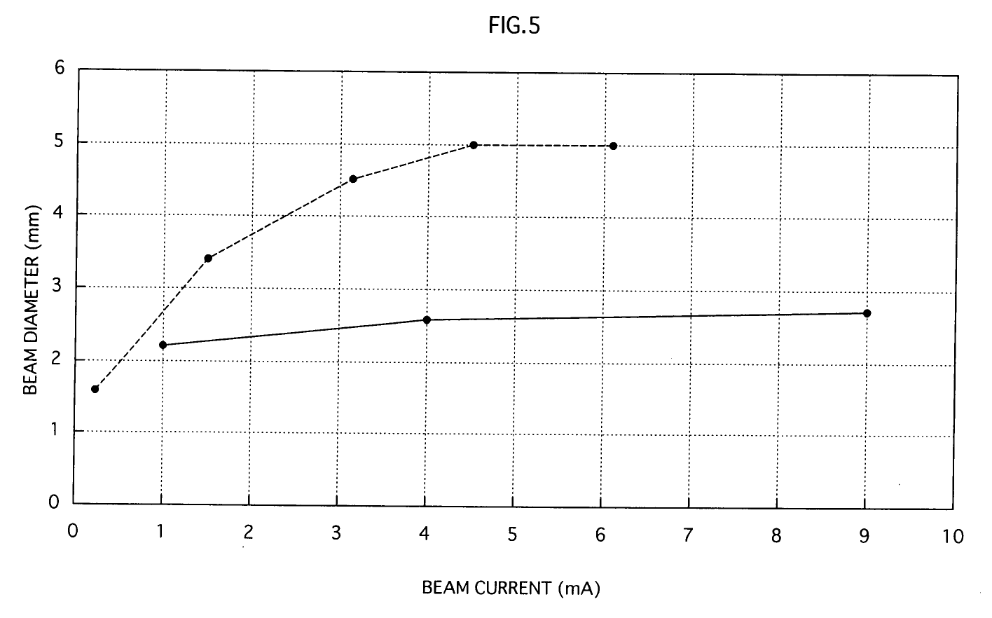

Further, the following describes the results of comparisons between the cold cathode electron gun 20 relating to the present embodiment and a hot cathode electron gun. FIG. 5 is a graph comparing the cold cathode electron gun 20 relating to the embodiment of the present invention and the hot cathode electron gun, in terms of fluctuations of the beam diameter at the main lens according to the beam current. In FIG. 5, the solid line indicates data of the cold cathode electron gun 20 relating to the present embodiment, and the broken line indicates data of the hot cathode electron gun.

The hot cathode electron gun relating to FIG. 5 includes the first grid electrode whose through-hole diameter G₁φ is 0.650 mm and thickness-plus-distance G₁t is 0.1000 mm. In this hot cathode electron gun, a voltage of the first grid electrode is 0V, a voltage of the second grid electrode is 618V, and a voltage of the third grid electrode is 7160V.

As shown in FIG. 5, for this hot cathode electrode gun, the beam diameter at the main lens is 1.61 mm when the beam current is 0.24 mA, 3.40 mm when the beam current is 1.53 mA, and 4.50 mm when the beam current is 3.19 mA. Also, the beam diameter at the main lens is 5.02 mm when the beam current is 4.57 mA, and 4.98 mm when the beam current is 6.15 mA. Therefore, a fluctuation range of the beam diameter is 3.37 mm when the beam current is changed within a range of 0.24 to 6.15.

As can be seen from these data, the cold cathode electron gun 20 relating to the present embodiment can drastically reduce the fluctuations of the beam diameter, compared with the hot cathode electron gun.

[5] Modifications

Although the present invention is described based on the above embodiment, the present invention should not be limited to specific examples shown in the above embodiment. For example, the following modifications are possible.

(1) Although the above embodiment describes the case where the gate electrode 30d, the first grid electrode 31, and the second grid electrode 32 form the cathode lens 33, the present invention should not be limited to such.

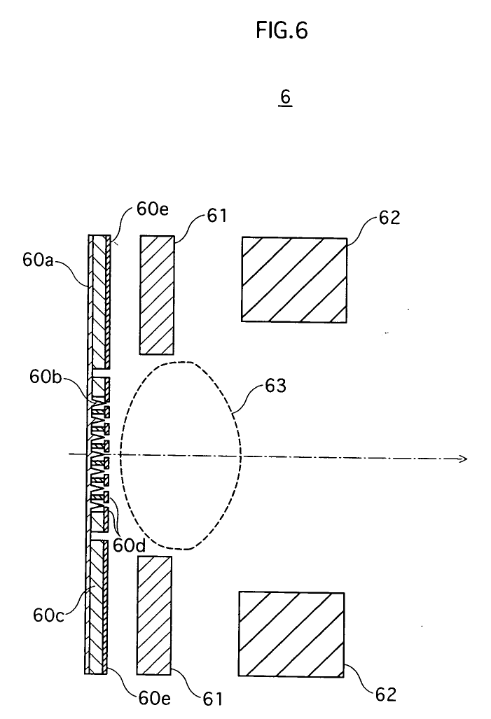

Also, the cathode lens may be formed in the following way. FIG. 6 is a cross sectional view showing a main construction of an electron gun relating to the present modification. As shown in FIG. 6, a peripheral focusing electrode 60e is provided on the periphery of a gate electrode 60dformed on an insulation layer 60c. The peripheral focusing electrode 60e is set to have a lower potential than the potential of the gate electrode 60d. The gate electrode 60d, the peripheral focusing electrode 60e, a first grid electrode 61, and a second grid electrode 62 form a cathode lens 63.

According to the present modification, the lens strength of the cathode lens 63 can be enhanced, and the electron beam can be concentrated into a finer thread. Accordingly, the spot diameter of the electron beam can be reduced, and high resolution of the CRT device can be maintained.

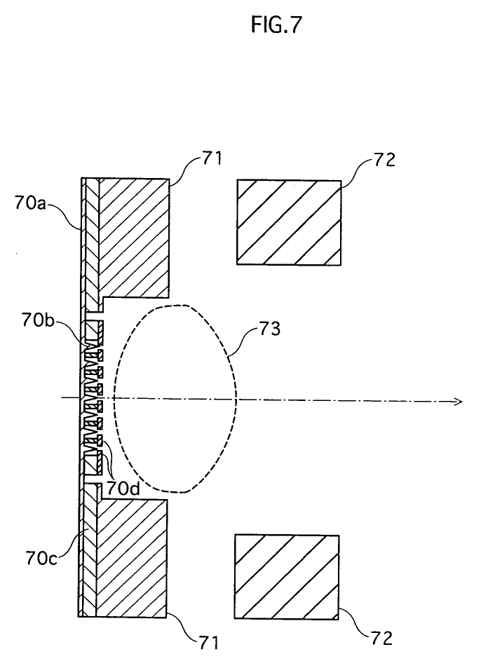

(2) Further, the cathode lens may be formed in the following way. FIG. 7 is a cross sectional view showing a main construction of an electron gun relating to the present modification. As shown in FIG. 7, a peripheral focusing electrode 71 is provided on the periphery of a gate electrode 70d formed on an insulation layer 70c. The peripheral focusing electrode 71 corresponds to the integration of the peripheral focusing electrode 60e and the first grid electrode 61 relating to the above modification (1). According to the present modification, too, the lens strength of the cathode lens 73 can be enhanced, and high resolution of the CRT device can be maintained.

(3) Although the above embodiment exemplifies the fluctuations of the beam diameter at the main lens according to the beam current for the three cold cathode electron guns that each differ in the dimensions of their first grid electrodes, the cold electrode gun included in the CRT device of the present invention should not be limited to the above three examples. A CRT device including the following cold cathode electrode gun also falls within the technical scope of the present invention.

To produce the effects of the present invention, the cold cathode electrode gun should have any first grid electrode whose through-hole diameter G₁φ is in a range of 0.15 to 0.60 mm inclusive and thickness-plus-distance G₁t is in a range of 0.10 to 0.35 mm inclusive.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A cathode-ray tube device comprising:
a phosphor screen; and
a cold cathode electron gun that includes
(a) a cold cathode having a field emitter array that emits a beam of electrons toward the phosphor screen, and a gate electrode that controls the emission,
(b) a first grid electrode that is positioned between the cold cathode and the phosphor screen,
(c) a second grid electrode that is positioned between the first grid electrode and the phosphor screen,
(d) an electron speed control unit operable to accelerate the electrons that have passed through the gate electrode, by a greater degree as a beam current carried by the beam of the electrons is larger, and
(e) a lens strength control unit operable to enhance a lens strength of an electron lens that is formed by the gate electrode, the first grid electrode, and the second grid electrode, by a greater degree as the beam current is larger.

2. The cathode-ray tube device of claim 1,
wherein a distance from the gate electrode to one edge of the first grid electrode closer to the phosphor screen in a thickness direction of the first grid electrode is in a range of 0.10 to 0.35 mm inclusive.

3. The cathode-ray tube device of claim 1,
wherein the first grid electrode has a through-hole that allows the beam of the electrons to pass through, and
a diameter of the through-hole is in a range of 0.15 to 0.60 mm inclusive.

4. The cathode-ray tube device of claim 1,
wherein a potential of the first grid electrode is lower than a potential of the gate electrode, regardless of an amount of the beam current, and
the potential of the gate electrode is higher as the beam current is larger.

5. The cathode-ray tube device of claim 1,
wherein the cold cathode includes a peripheral focusing electrode that is provided on a periphery of the gate electrode, that has a thickness substantially equal to a thickness of the gate electrode, and that has a lower potential than the gate electrode.

6. The cathode-ray tube device of claim 5,
wherein the peripheral focusing electrode and the first grid electrode are integrally formed.

7. The cathode-ray tube device of claim 1,
wherein the lens strength control unit enhances the lens strength to form a crossover in the beam of the electrons, at one side of the gate electrode closer to the phosphor screen.
